(19) United States
(12) Patent Application Publication
(10) Pub. No.: US 2026/0113314 A1
(43) Pub. Date: Apr. 23, 2026

(54) SECURITY KEY FOB

(71) Applicant: MIS Electronics Inc., Richmond Hill (CA)

(72) Inventors: Soorena Merat, Toronto (CA); Saeid Mohmedi, Janetville (CA)

(21) Appl. No.: 18/923,790

(22) Filed: Oct. 23, 2024

(51) Int. Cl. H04L 9/40

(52) U.S. Cl. CPC H04L 63/0861; H04L 63/1425

(57) ABSTRACT

The present invention discloses a system and method for assessing the security risk of a user by analyzing human biometrics using a neural network model. According to an embodiment, the system collects human biometrics data from biometric sensing device of a user, analyses the human biometrics data using an adaptive neural network model that performs rational inference to learn the correlation between the human biometric and daily behavioral anomalies and provide an assessment of the user risk based on identified behavior anomalies. The system may identify definitive risk and assign a risk score for the user using a machine learning model or using a behavior-risk correlation table. The system may take preventive actions to prevent security issues based on the risk score.

### FIELD OF THE INVENTION

The present invention relates in general to personal security systems in the digital environment and in specific to an innovative system and method to enhancing personal security in the digital environment through the utilization of everyday human behaviors.

### BACKGROUND OF THE INVENTION

In the digital age, where users of varying ages and health conditions increasingly depend on computing devices, the disparity in cyber-security awareness poses a significant risk. Some users are inherently more susceptible to cyber threats due to limited awareness or cyber competence.

The correlation between individuals' daily behaviors and their online actions is a key factor in understanding and mitigating cyber risks. Research indicates that a person's mental state, whether permanent or temporary, significantly influences their online behavior, thereby affecting their vulnerability to cyber-attacks. For instance, individuals experiencing mental impairments might exhibit impulsive or erratic online behavior, increasing their exposure to potential cyber threats.

The inherent risks in online environments are amplified by the boundless opportunities they present, which can be particularly challenging for those with fluctuating or persistent mental conditions. The way these conditions manifest can vary greatly, impacting how individuals interact online. By closely examining the link between daily life behaviors and online actions, a deeper insight can be gained into the cyber resilience of individuals, enabling the development of more effective strategies to protect them in the digital world. Understanding these correlations is crucial for creating safer online spaces, especially for those whose mental state might make them more susceptible to cyber risks.

The correlation between individuals' daily activities and their online behavior is a critical factor in understanding and predicting the timing of cyber-attacks. Cybercriminals often rely on assumptions about the best time to launch attacks based on these behaviors. For instance, when people engage in routine pleasure-seeking activities, they may become more vulnerable to cyber threats. This susceptibility is heightened in individuals experiencing mental health challenges, as their altered brain mechanisms might lead to an increased pursuit of rewarding experiences online.

The brain's pleasure mechanisms are complex and can be manipulated by cyber attackers. In scenarios where individuals experience a heightened sense of displeasure, the pursuit of online pleasure can act as a psychological motivator. Cybercriminals exploit this by timing their attacks to coincide with these periods of heightened online activity or vulnerability.

Moreover, the subtleties of human behavior, such as the nuanced shifts in online activity during different times of the day or during specific mental states, can often go undetected in traditional data models. This makes it challenging to effectively measure and mitigate risks. Understanding these behavioral patterns and their correlation with online activities is therefore crucial in developing more sophisticated and proactive cybersecurity strategies.

There are some existing solutions proposed to assess cybersecurity awareness or cyber risk of an entity. U.S. Pat. No. 10,511,535 B2 titled “inferential analysis using feedback for extracting and combining cyber risk information” describes systems and methods for assessing the risk of a cyber security failure in a computer network of an entity, using a computer agent configured to collect information from at least one accessible Internet element. The system assesses the cyber risk by evaluating the collected circumstantial or indirect information. US Patent Publication 20200135049A1, titled “Method and system for evaluating individual and group cyber threat awareness” analyzes users response to offensive actions and defensive action and scores cybersecurity awareness of the user. However, this invention requires users' action during cybersecurity awareness evaluation.

The correlation between an individual's daily activities and their online behavior is a critical factor in assessing cyber vulnerability, particularly for those with cognitive impairments. Such individuals may not actively participate in evaluations, making it challenging to gauge their cybersecurity awareness accurately. Therefore, it's essential to continually assess their vulnerability whenever they connect to any public or private network.

In 2014, the researchers from Johns Hopkins reported a faster pace of recorded gaze for the people who are less patient, so they would move their eyes at greater speed. The researcher then compared the volunteer's gaze patterns to their trend of impulsivity and found a surprising correlation. In 2010, a study presented the possibility to identify a stray mind by tracking eyes during a reading task. The researchers of the University of Pittsburgh found that eye movement varies depending on the reader's attention or wandering because eyes tend to skip the words during the wandering phase. In 2012, a study by the research team at the university of southern California suggested that the study of eye movements can potentially identify certain types of neurological disorders. This research is focused on how neurodegenerative disorder can affect gaze control and attention during a TV-watching task. A team of researchers at the University of Illinois are studying the possible ways to diagnose psychiatric diseases using gaze tracking and eye movements. They have discovered a vibrant reflection of the neural circuit defects into the irregularities in the way that the eye tracks the objects. For example, schizophrenic patients had difficulties keeping their eyes focused on even very slow-moving objects.

Current solutions fall short in effectively evaluating an individual's cyber competence without actively considering their daily behavioral patterns. A comprehensive approach that aligns the specific day's recorded activities with online behavior can provide a more accurate assessment. This method recognizes the importance of understanding how daily routines and habits influence online actions and, consequently, an individual's susceptibility to cyber threats. This approach is especially crucial for those whose cognitive abilities might impact their decision-making in online environments.

Consequently, there is a growing necessity for a method and system that can seamlessly correlate an individual's daily activities and personal behaviors with their online behavior. This approach aims to assess a user's cybersecurity competence in a passive manner, without the need for active participation or dedicated evaluations from the user.

### SUMMARY OF THE INVENTION

The present invention is a system and method for enhancing personal security in the digital environment through the utilization of everyday human behaviors. This system employs wearable devices, such as FOB-RING, to continuously collect comprehensive data on an individual's daily activities and biometric patterns. The collected data is processed to generate a personalized security framework that actively safeguards the user during secure activities, including financial transactions, internet browsing, or online transactions. By leveraging advanced technologies, this invention provides a unique, user-specific defense mechanism against cyber threats, ensuring a more secure and individualized experience in the digital realm. Biometric data includes AI controlled random fingerprint check, random controlled hand gesture check, and random controlled eye movements check. AI Behavioral model is developed as part of this patent.

The Security FOB-RING patent focuses on enhancing physical access control by integrating biometric data and user behavior patterns for authentication. It functions within a distributed network that enables data collection and behavioral mapping. The device utilizes biometric authentication, user behavior analysis, and a distributed network to process data in real-time. Its core technology likely incorporates embedded sensors, wireless communication, and machine learning algorithms. The Security FOB-RING aims to provide advanced security solutions for physical access, potentially replacing traditional keys or access cards with a more personalized and dynamic system. The integration of biometric data, user behavior analysis, and distributed networks into a physical access control device is considered novel.

The system consists of a centralized data collection unit personalized to each user and connected to a network of field devices that gather personal data through biometric sensors. This setup is designed to sync personal daily behaviors with online activities. The system aggregates biometric data, including eye movement, captured by devices like wearable biometric trackers. This data is then analyzed using an adaptive neural network model. The neural network, potentially based on a Generic-Leaky-Integrate-And-Fire (GLIF) model, is designed to discern patterns and correlations between biometric data and potential mental disorders.

For each user, the system assigns a cyber competence score, which is derived either through machine learning algorithms or based on established correlations between mental disorders and cyber risks. This score reflects the user's ability to navigate the digital world safely, taking into account their unique biometric indicators and daily activities. This tailored approach ensures a more personalized and effective way of enhancing cyber security, aligning with the user's specific needs and behavior patterns. By understanding these correlations, the system can assess the user's cyber competence, considering how their mental state might influence their online behavior and susceptibility to cyber risks.

The central data collection unit is personalized and connects to a variety of field devices. These devices are designed to gather personal data, primarily through biometric means, and relay this information to the central unit. This unit, in turn, is linked to several actuating devices requiring stringent security hardening for field operations, such as credit cards, security fobs, and similar tools.

The central data collection unit stands as the core of this system, processing and interpreting biometric data to create a comprehensive security profile for each user. This profile is then utilized to enhance the operation of connected field devices, focusing specifically on personalized and behavioral security information. The system's ability to adapt to individual user profiles and behaviors ensures a heightened level of security in various applications, from financial transactions to access control.

The core functionality of this system lies in its ability to leverage advanced neural network models for the analysis of the gathered biometric data. These models are adept at drawing rational inferences and learning correlations between the biometric data and the user's behavioral patterns. This analysis is crucial in enhancing the security protocols of both the central unit and the connected field devices.

By integrating behavioral and personalized security information, the system significantly improves its focus and efficiency in operations. An integral part of the system including an adaptive neural network model, based on the Generic-Leaky-Integrate-And-Fire (GLIF) architecture, to augment its ability to precisely interpret various physiological indicators. This enhancement is pivotal in strengthening the cybersecurity aspect of the field devices, ensuring that each device operates securely and effectively in response to the personalized data it receives from the central unit.

The central data collection unit is intricately linked with numerous field devices that gather personal data through biometric sensors. This central unit not only receives biometric data but is also connected to various actuating devices essential for field operations, such as credit cards and security fobs. These devices require robust security hardening to ensure safe and secure operations.

In a preferred embodiment, the system comprises a wearable ring equipped with an embedded touch sensor that is uniquely personalized and seamlessly integrated with various field devices such as security fobs and cards. These devices are furnished with biometric sensors that capture personal data, subsequently transmitting it to a central data collection unit. This configuration forms the core of a human biometric-based cybersecurity system as outlined in the present embodiment. The system's efficacy relies on these interconnected components, each playing a vital role in collecting, analyzing, and applying biometric data to enhance personal security and assess cyber competence.

Additionally, the system thoughtfully integrates personal items such as credit cards and security fobs, creating a secure link between their usage and the user's behavioral patterns. This ensures that these essential everyday tools are used safely, with the system dynamically adjusting security protocols based on real-time behavioral and temporal data. As a result, the system offers a robust security framework that not only protects personal data but also elevates the security of routine operations, making it a state-of-the-art solution in the field of personal security and biometric technology.

The central unit functions as a personalized and securely private unit, processing and analyzing biometric data to enhance personal security measures. This data is crucial for creating a tailored security profile for each user, optimizing the performance of connected field devices. These devices, now armed with personalized and behavior-based security information, operate with heightened efficiency and security.

The system's focus on personalization is achieved through sophisticated data analysis techniques. Biometric inputs, like eye movement patterns, are intricately analyzed to discern potential risks or anomalies. The system utilizes a combination of advanced algorithms, including wake-sleep algorithms in conjunction with spiking recurrent neural networks, to effectively learn and adapt to the user's unique behavioral patterns.

During the sleep phase, the system predicts gaze transitions during intense visual tasks by leveraging the temporal context of biometric data. In the wake phase, it establishes correlations between these gaze patterns and potential mental disorders. Training of the neural network model involves using biometric data represented by interconnected networks of generic leaky integrate-and-fire neurons. These are further refined with spike-timing-dependent plasticity (STDP), ensuring that the system remains adaptive and responsive to the ever-changing behavioral patterns of the user.

It is therefore an object of the present invention to continuously monitoring the user's daily activities and habits, as recorded by wearable technology. This data is then used to create a tailored security profile for each user, enhancing their defense against cyber threats, especially during critical activities like online transactions or internet usage.

It is another object of the present invention to provide a system and method by integration of biometric authentication with a physical access device, offering a dynamic and personalized security layer.

It is another object of the present invention to introduce a groundbreaking approach that correlates an individual's daily behaviors during routine activities with their online behavior.

It is another object of the present disclosure to provide a system by integrating insights from everyday behavior with digital interactions and offers a more holistic understanding of an individual's requirements, paving the way for more targeted and effective support and content personalization.

### BRIEF DESCRIPTION OF DRAWINGS

Embodiments herein will hereinafter be described in conjunction with the appended drawings provided to illustrate and not to limit the scope of the claims, wherein like designations denote like elements, and in which:

FIG. 1 is a block diagram of network environment showing the interconnectedness of the human biometric data collection points and the central data collection unit according to an embodiment of the present invention;

FIG. 2 illustrates a high-level visualization of system architecture, and a deep hidden layer of an adaptive neural network model designed in accordance with an embodiment of the present disclosure;

FIG. 3 illustrates functional modules of a human biometric-based wearable ring, featuring an embedded touch sensor that is personalized and seamlessly integrated with various other sensing elements of the smart ring such as heart bit sensor, according to the current embodiment of the present disclosure;

FIG. 4 is a block diagram illustrating the field IoT nodes determination of cyber based on human biometrics data gathering in accordance with an embodiment of the present disclosure;

FIG. 5 illustrates a framework of the network security system integration with the private data collecting unit to protect an enterprise network in accordance with an embodiment of the present disclosure;

FIG. 6 is an exemplary security framework that is to establish a secured connection between the private data collecting unit to an enterprise network with an embodiment of the present disclosure;

FIG. 7 is a process flow chart for assessing the cyber competence score of a user in accordance with an embodiment of the present disclosure, and

FIG. 8 illustrates an exemplary computer system in which or with which embodiments of the present invention may be utilized.

### DETAILED DESCRIPTION OF THE INVENTION

The detailed description set forth below in connection with the appended drawings is intended as a description of exemplary embodiments in which the presently disclosed process can be practiced. The term “exemplary” used throughout this description means “serving as an example, instance, or illustration” and should not necessarily be construed as preferred or advantageous over other embodiments.

The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and human operators.

Embodiments of the present invention may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, optical disks, and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within the single computer) and storage systems containing or having network access to a computer program(s) coded in accordance with various methods described herein, and the method steps of the invention could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly or via one or more intermediary media or devices. As another example, devices may be coupled in such a way that information can be passed there between while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic. As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

It will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

Embodiments of the present disclosure are described with respect to the data that provide accurate monitoring and measurement of the user behavioral condition. The proposed system can use any other human biometrics data to determine user condition or disorder or a user and assess cyber risk of the user. The system may restrict network access of the user and take preventive security measures based on the assessed user behavior.

It has been observed that humans have a natural capacity to understand interpersonal and intrapersonal communications. These interactions become such ingrained parts of daily life that impacts on physiological and behavioral biometrics. One can derive a large range of interpretations on human behavior circumstances. Biometric data present a vital role in daily perception.

Research has revealed a link between the pace of eye movements and an individual's level of patience, showing that less patient individuals tend to move their eyes more rapidly. By analyzing gaze patterns, researchers have discovered correlations between impulsivity and the speed of eye movements. Furthermore, studies have demonstrated the potential to identify mind wandering during tasks, such as reading, by observing how eye movements vary when attention shifts. Eye tracking is now being explored as a diagnostic tool for neurological and psychiatric conditions. Research into neurodegenerative disorders has shown that defects in neural circuits manifest in irregularities in eye tracking. For instance, schizophrenic patients often struggle to focus on slow-moving objects, which reflects a breakdown in the brain's ability to process visual information. These findings open new avenues for diagnosing mental health disorders through gaze tracking and eye movement analysis.

The proposed system correlates Biometric-Behavior tracking patterns and brain abnormalities that allow it to identify the best protection solution for high-risk individuals and create more focused mitigations for them.

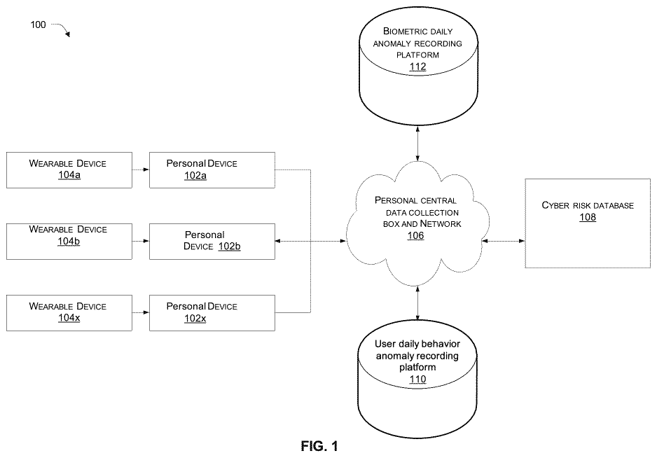

FIG. 1 is a high-level block diagram of the cyber security system 100 illustrating a network environment. A human biometric-based cyber risk assessment system 108 can use in accordance with an embodiment of the present disclosure to receive human biometrics data from a user device (e.g., user device 102a, 102b, . . . , 102n) through a personal central data collection unit and network 106. The user devices 102a, . . . , 102n may have a client application running to collect biometrics data from respective wearable devices 104a, 104b, . . . , 104n attached with it and send the human biometrics data to the cyber risk assessment system 108.

The wearable device 104a, . . . , 104n may be a smart ring, VR headset or any other wearable device capable of reading and tracking biometric data and recording them. A wearable device may have a tracking sensor that can track the movement of a user. In some embodiments, the cyber risk assessment system 108 may collect human biometric data, including movement data from user devices 102a, . . . , 102n, which can be a mobile phone, portable device, laptop, desktop, or any other computing device. The user device itself may have biometric readers that can scan user movement. The cyber risk assessment system 108 can also get biometrics data of the user from independent biometric data tracking devices (e.g., a camera or tracking sensor). Tracking sensors, biometric data tracking devices, and the biometric readers are referred to interchangeably throughout this document. The cyber risk assessment system 108 may also get movement from a surveillance camera and physically installed tracking sensors.

In an embodiment, the client application running on a user device (for example, user device 102a) may also collect the network activity log of the user and share the network activity log with the cyber risk assessment system 108. The client application can be configured to collect and share the network activity log data only when system 108 identifies that the cyber risk score of a user using the user device is below a predefined threshold.

In an embodiment, the cyber risk assessment system 108 may also be implemented on the user devices in form of a software application and the user device may use network services whenever required for data processing, collecting historical data, and storing the analyzed data. System 100 may use an adaptive neural network to analyze the human biometrics data to determine human condition and disturbance level and determine the risk score of the user.

In an embodiment, Cyber risk assessment system 108 provides a conditional correlation database 112 to use human daily biometric and behavior that maintains pre-analyzed behavior patterns with a certain risk level. Cyber risk assessment system 108 may match the behavior pattern of received human biometric data with behavior patterns stored in conditional correlation database 112 and identify a risk or disturbance level. In a preferred embodiment, Cyber risk assessment system 108 may use an adaptive neural network model to determine disturbance level based on the received human biometrics data. Once the high risk pattern or disturbance level is identified, system 108 may refer to a cyber risk correlation database 110 to determine high risk behavior disturbance level.

In an embodiment, Cyber risk assessment system 108 may use a machine learning model to determine a cyber risk for the user based on the Biometric model or behavioral disturbance level. The conditional correlation database 112 and conditional to cyber risk correlation database 110 can be updated with external input or based on analysis of the adaptive neural network model and machine learning model used in the system 108.

It is to be understood that this illustration is part of a broader explanation and should not be seen as limiting the scope of the system but rather as a visual representation of its functionality and design, where similar elements are denoted by like designations.

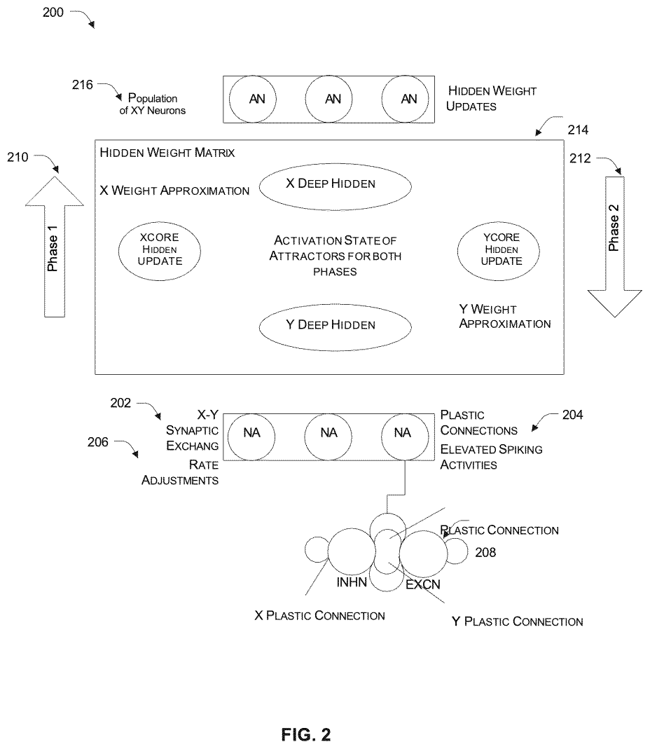

FIG. 2 illustrates a high-level visualization of system architecture and hidden layers of an adaptive neural network model designed in accordance with an embodiment of the present disclosure. Cyber risk assessment system 108 may use the adaptive neural network model architecture 200 to train itself. System 108 may use a hybrid computation model, which performs rational inference to learn the correlation pattern between biometric and behavioral condition. The model learns the pattern of biometrics such as movement, then integrates it with a two-phase learning machine algorithm.

In phase 212, the model predicts upcoming behavioral transitions during more complex and previously unseen visual tasks by leveraging the temporal context of movements and fixations, simulating attention shifts accordingly. The model in phase 210 uncovers the correlating points between the simulated patterns and the risk model. The adaptive neural network architecture 200, designed to learn the recorded biometric patterns, consists of several populations of equivalently structured, interconnected leaky integrate-and-fire neurons 202, which are trained using spike-timing dependent plasticity (STDP) connections 204.

The model may implement learning rules based on correlations, with a flexible learning rate that is modifiable during the hidden layer learning cycles. This flexibility ensures that the learning dynamics are maintained while avoiding feedback effects from recurrent rates. To optimize training for specific purposes, the firing rate can be adjusted using the provided firing rate adjustment option 206. This adjustment fine-tunes the system, enhancing its adaptability and performance in specialized tasks.

It is observed that the stall bio-points can cause a reduction in the convergence patterns and increase the final inference error, which results in a decrease in final correlation. Hence, to maintain the correlation learning rate, the two-phase algorithm 210-212 can simulate the behavior transitions while unlearning the stalls. Also for low learning rates, the proposed model is tested and convergence speed has been improved with a reduced rate of inference error. The model may use plasticity 208 and populations with larger excitatory than the inhibitory, also the input population that is composed of a large number of spike-generators that provides the Bayesian firing mechanism.

The model may use a weight matrix structure that is based on the inference learning after the X+H(1−n)=Y and the hidden weights are associated with the excitatory neuron assignments in the H layer 214. The model generates an output population of XY Neurons 216 that can further be used for training.

The logistics are composed of the binary stochastic variables, which bring up to date when the entire unit goes through the passes of a run. The probability of turning the value J is the function of its immediate ancestor K, so the weight matrix can be updated based on a directed connection of Wjk for the

$$\frac{1}{2 + exp ( - {b}_{i} - {Σ}_{i} {S}_{j} {W}_{jk} )}$$

Each of the equivalently structured populations of the GLIF neurons may consist of 2000-4000 neurons with 5% inhibitory and 95% excitatory neurons. After several trials of other ratios of INH-EXC, it has been identified that the 90-10 ratio is a better match for this medal disorder determination application. In an example implementation, the input stage population may consist of a Poisson model of 2000 spike generators, with a Gaussian shape average network bust of 0.3 s as a firing rate profile.

The model may use two forms of STDP to learn the plastic connections. For between excitatory plastics, the three-legged, and for between inhibitory to excitatory, the two-legged rule can be applied. The weight matrix structure and inference of the learning network after successful passes reflect the population activity vs the desired activity in a diagonal format, which is a good representation of the Bayesian shape input patterns over the neuron population. The hidden weights are designed to be a part of the excitatory population's connections and weights are assigned to these hidden layers by averaging the strongest connection in the surrounding peripherals of an excitatory neuron.

The hidden (H) plane 214 consists of the decoded inference learning based on the excitatory firing rate reflection into the surrounding peripherals of excitatory neurons. During the inference test phase, all the plastics can be disabled. In this model, the excitatory neurons that are highly activated can create strong feedback on any of the three or double-legged connection models. To balance this effect, the model may maintain the learning rate in a low range and ensure that the continuously external input is presenting and presentable patterns are being excited. Hence, if the learning rate is increased, the recurrent dynamics will reinforce the neurons that are already highly excited. This can potentially create the weight clusters and interrupt the dynamic of the network by collapsing the active sub-group into the clusters.

The described model learns the bio-movement and stall patterns and expands it in collaboration with the two phase algorithm. In the first phase 210, the network learns how to predict by projecting a cheap approximation of the real posterior, which in this case are the parameters of the pre-recorded behavior condition or disorder model. All the activation in the second phase 212 is the projection to the simulated network attractors. The firing rates and conditions of input populations can be all simulations based on the GLIF results.

The attractor states are technically a subgroup of neurons with high spiking and excitatory activation. In the wake phase, however, extra input patterned layers are presented. In the first phase, the model may apply learning rules that would be correct if the samples are taken from the true posterior. True posterior in this case, is the samples from the disorder model that is pre-recorded and borrowed from external sources. What drives the weight Metrix in this proposed model is the pre-established model from the GLIF and also driving the weights toward sets of weights for which the approximate posterior is a good fit for the real posterior while applying a 0.7 s for weight normalization.

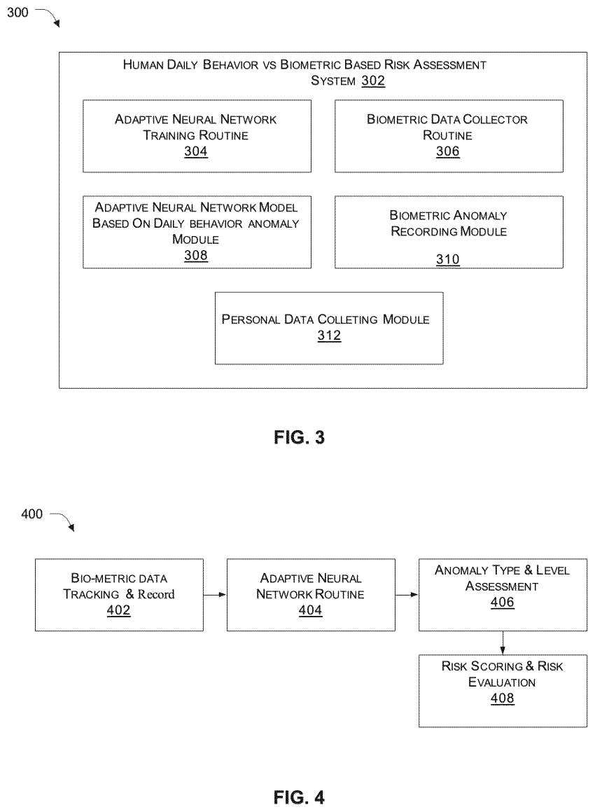

FIG. 3 illustrates functional modules of a human biometric-based cyber risk assessment system in accordance with an embodiment of the present disclosure 300. In one embodiment the functional module of a human biometric-based wearable ring, features an embedded touch sensor that is personalized and seamlessly integrated with various other sensing elements of the smart ring such as heart bit sensor. The ring collects personal data and transmits it to a central data collection unit. This setup forms the core of a human biometric-based cybersecurity system, in line with the current embodiment of the system.

The human biometric-based cyber risk assessment system 302, same as system 108, includes an adaptive neural network model training module 304. The adaptive neural network model training module 304 may use the model learning architecture 200 to train the model using a minimal training dataset. Once the adaptive neural network model is trained with basic intelligence, the model can be used for determining the behavioral disorder or disturbance level of a user.

The adaptive neural network model is trained using recorded bio-movement data comprising of several populations of equivalently structured, interconnected, bio-movement data represented in form of generic leaky integrate-and-fire neurons, which are trained with spike-timing-dependent plasticity (STDP).

System 302 includes a biometric data collection module 306 configured to collect human biometrics data from a biometric reader, which can be a movement tracking device, or movement tracking sensor embedded into the user device or acting as an independent device. System 302 uses an adaptive neural network model-based behavioral disorder determination module 308 to analyze and determine the disorder or disturbance level of a user based on the biometric data.

The adaptive neural network model-based behavioral disorder determination module 308 analyzes the human biometrics data using an adaptive neural network model that performs rational inference to learn the correlation between the human biometrics and behavioral disorder to determine risk. As described above, the adaptive neural network model can be trained using a two-phase machine learning engine in combination with a spiking recurrent network model. The machine learning engine is used to predict behavior disorders for a set of definitive cyber risks.

The two-phase machine learning engine in one mode predicts next bio-behavior transitions during a more intense and previously unseen visual task by exploiting the temporal context of fixation and simulating attention shifts. The machine learning engine in wake mode undercovers correlating points between simulated bio-patterns to behavior disorders. In an embodiment, the adaptive neural network model can be developed based on Generic-Leaky-Integrate-and-Fire (GLIF) neural network model.

System 302 may further use a cyber risk score determination module 310 to determine a cyber risk score based on the determined behavior disorder. Module 310 may use a machine learning model to predict the cyber risk score of the user based on the determined disorder or disturbance level. Module 310 may also use a correlation database representing the behavior disorder to cyber score correlation to determine the cyber risk score of the user.

System 302 includes a network access control module 312 configured to control network access of the user based on the cyber risk score. The network access control module 312 may initiate different prevention and correction actions based on the determined cyber risk score of the user. In an embodiment, module 312 may send an alert about their vulnerable status and how a cyber attacker can take advantage of such vulnerability. Module 312 also analyzes the network traffic log of the user and identifies activities that are suspicious and can take corrective measures.

Module 312 may automatically disable access to protected network resources based on predefined rules related to behavior disorders. Module 312 may similarly disable all network access, including wireless and wired connections if the cyber risk condition and score of the user is very low. Module 312 may also inform other connected devices and users connected with the user and user device about potential vulnerability, without disclosing the actual behavior status of the user. As one will appreciate, a higher risk score indicates a healthy state of mind and may not require any preventive or corrective action. A lower risk score below a threshold indicates behavior disorder or disturbance, and, hence, the system may take corrective and preventive action.

In an embodiment, system 302 may determine a correlation matrix by correlating the cyber risk score of the user with the network activity log of the user, wherein the network access is controlled based on the correlation matrix. The system may determine the cyber risk score of the user based on the correlation matrix using a machine learning model.

In an embodiment, the neural network model can be trained to detect behavior disorder or disturbance level of the user based on other biometric data, such as pulse rate, heartbeat, etc. But it has been identified that the bio-movement data can provide a better estimation of the actual behavior condition of the user. Embodiments of the present disclosure are hence explained with respect to bio-movement data.

FIG. 4 is a block diagram illustrating the determination of cyber risk score based on human biometrics data in accordance with an embodiment of the present disclosure 400. A movement tracking and processor 402 tracks bio-movement of the user closely to detect fast or slow movement with respect to surroundings or collection of objects, color, etc. collectively referred to as bio-movement data. The movement tracking and detection processor 402 may be part of a user device or a handheld device attached to the user device through a wireless communication interface or an independent device with a data communication interface.

The processor 402, which may be a microprocessor, may send the bio-movement data to an adaptive neural network model 404. The adaptive neural network model 404 may be implemented as a cloud service to provide faster processing and better accuracy in determining behavior status, or disturbance of a user. Adaptive neural network model 404 may provide distraction type and distraction level assessment score 406, which may also be represented and summarized in form of a behavior disorder or disturbance. In an embodiment, system may perform cyber risk scoring and risk assessment 408 based on the behavior distraction type and/or distraction level assessment score.

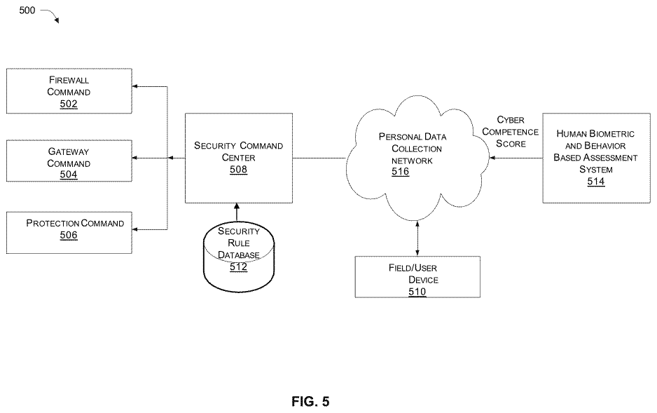

FIG. 5 illustrates a network security system integration with the cyber risk score assessment system 500 to protect an enterprise network in accordance with an embodiment of the present disclosure. The human biometric-based cyber risk assessment system 514, same as system 302, may send the cyber risk score to a cyber security command center 508 through a network 516. The Cyber security system 508 may refer to a security rule database 512, which may have predefined assess request processing rules associated with the cyber score. The cyber security system 508 may alert the firewall command 502, gateway command 504, and other protection command resources 506 about the cyber risk score of a user accessing user device 510. The cyber security system 508 may isolate the user device 510 from network 516 if the cyber competence of the user is very low or restrict the user's access to a protected network area.

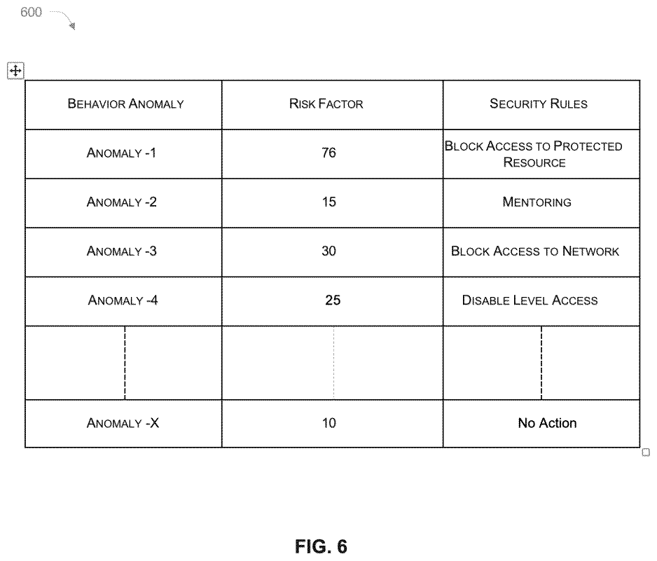

FIG. 6 is an exemplary security rule that can be used to protect an enterprise network based on a cyber score in accordance with an embodiment of the present disclosure. In an embodiment, the network access control module or the cyber security system may use predefined rules to take appropriate actions using the reference table 600. Table 600 maintained in the form of a database may include mapping of behavioral disorder, risk factor scores, and security rules. For example, the rule may indicate that for disorder-1, and a cyber risk score below 80%, access to protected network resources should be blocked. If the cyber score is greater than a defined threshold (e.g. 80%), no action is required and the user can continue using the network services. For a complete score below another threshold (e.g. 35%), the system may block or disable network access.

Graphs 600 shows the result of a test run on a variety of mobile platforms such as cellular phones and VR glass. The software recorded the attendance of participants to the task every 1 s. All the tracking parameter's data is later reviewed against the designed features of behavior distraction. Tasks are designed according to the distraction rules of the visual hallucinatory world with recordings of haptic responses in real-time, faster than real-time, or slower than real-time. The fast and slow modes, in contrast, presents visual effects to determine the participant's strategy and focus wandering.

The duration of the test for each participant was less than a half-hour and the total time for data collection was about one hour. Participants were given written instructions about the intent of the experiment, without any mentions of the curious distractions, designed into each task. The participant was told to try to obtain the highest possible score, following any desired strategy during various test scenarios.

For all scenarios, all variations of the ten bio-tracking parameters were recorded during the multiple tasks. It was noted that variation of parameters is not uniformly linear for some scenarios, but parameters regression is coherent, and before updating the weight matrix, the weight convergence can be examined. In case of over or under-simulation, the results will run over. The goal of the test scenarios was to get the participants into the close situation of the maximum distractions by studying the reactions of the participants via their movement patterns. Hence, for the same categories of participants, one can expect similar results, even if the scenario and tasks are assigned in completely random order.

Each scenario was 3 mins long and prior to starting, each participant had to take a few trials runs. The details of attendance in trial practices were not recorded, but final parameter sets in each trial were recorded to note the data regression. The real scenarios were selected, that were different than trial practice, intended to stimulate the maximum random behavior twists and distraction. Finally, at the end of the test, a questionnaire was completed by a participant about the level of attention that they normally require during their daily work and proficiency of electronic devices as well as the duration of electronic devices usage per day.

The GLIF algorithm was run four to six times in each scenario with different learning rule and parameters. This allowed the algorithm to adjust the intensity of learnings rules within the spaces with less good results. Some adjustments were also made to enable reasonable inference learning. This adjustment focused on the spike-timing dependent plasticity (STDP), to improve the GLIF performance and better the learning curve. The first adjustment was to compensate for the inconsistency of the human eye while switching between tasks with a scenario.

The second adjustment was to remove the complete bio-stall after a certain time, which after a certain time was considered a non-attended task. There was also some captured uncertainty when the participant could not switch easily between releasing the haptic and switching the visual task. The tasks assignment were random but the task sequences and duration were identical between the participants. And since the eye-tracking parameters are discretely different, therefore they are being studied at the pairwise level. This means the GLIF learning task is conducted within each scenario and not between them.

The two-phase algorithm, however, uses the learned pattern of attendance between the participants and projects a simulation close to the pre-recorded results, and applies the maximum likelihood learning. Additionally, the haptic reactions were reviewed with respect to the attendance strategy. Finally, several types of correlation-indexes were generated to summarize different scenarios and how they converge into the close situation of the bio impairments in cases like the curious distractions.

When comparing the results of the above process with the pre-recorded data, the first few null hypotheses were rejected with high confidence, because there was evidence of the pre-recorded data regression has outperformed this algorithm. Similarly, the return null hypothesis was also rejected for every scenario, due to a similar situation. Additionally, for most scenarios, the pre-recorded regression has outperformed the algorithm, except for the time that participants were forced to switch between tasks much quicker. Besides the statistical comparison of this experiment's visual tracking parameters with the pre-recorded data of the certain condition, the WSA tends to predict a development pattern with the set target according to the bio impairment parameters.

Hence, further looking at the performance of all participants and the WSA performance of specific scenarios, a strategy that is thought to give the best result, via risk assessment for each scenario. The algorithm success was initially to bring at least nearly 80% of bio-tracking parameters per scenario, up to near 100%. While the rest of the percentages were part of the participants learning curve and not a great contribution to the results. It was also noted that in specific cases some of the randomized parameters were also learned by the participants after the final results were reviewed. Hence, a selection of tasks was normalized to 50% contribution in favor of another group, which remained 100% random to the end. In addition, the best performer among the participants was recognized and tasked by more influential scenarios, to be more challenged by the differences in their recorded parameters. FIG. 6 presents a summary of inference learning gain or weights across each task per different passes. A variable firing rate is dominantly controlled and measured until the sleep phase is initiated.

The system is designed based on the experimental results that biometric anomaly and issues, can introduce a cyber-risk via impaired hedonic capacity and compulsive cognitive seeking. A generic leaky integrate and fire neural learning model has been used to develop a mathematical model of bio-tracking under multiple concurrent tracking including touch, heart rate, etc., for a user. The mathematical model is then learned by a two-phase algorithm to predict the future development of events. The algorithm results were then compared with pre-recorded experiments, that were experimented from other previous researches, to understand the risk per user. A multi-platform experimental test was adopted to include the haptic feedback into the model. The system uses number of field devices such as smart ring, VR glasses, mobile cellular devices, and bio-track wearables and many more, the heart of the system is a fully personalized and secured box that gathers every user bio data for analysis.

As one will appreciate, the system results of analysis could be extended in numerous ways to support another use case. For example, the system can be used with some modification to capture a variety of safety risks associated with handling sensitive tasks or allowing people into sensitive environments. The other suggested extension to this system is to investigate different scoring mechanisms and penalty factors for corrective action developments.

The proposed system can prevent different types of risk exploitation, and provide extra security hardenings, especially using a user with a disturbed personal state. It has been observed that risk of exploitation in the form of social engineering can be designed in many ways, using several channels over the smart computers or cellphones that target the bio-disturbance system deep inside the brain by presenting a risk mechanism and promoting the concept of human distraction.

Different brain stimulation can associate a specific variety of components and may dissociate others. Unlike associative liking, the target components dissociation increases the risk of reward-seeking via bypassing security and the abstractive reward incentive. The person who is experiencing casualties is often confused with the functional abstraction and often considers security bypass as positive reward-seeking involving eager anticipation.

The system uses a specific type of tracking, which records the anticipation function via biometric distraction as a major contributor to the hyper-activation of the curious distraction on an impaired personal capacity. Hence, a neural network models the biometric distractions during daily activities to map the entire tracking parameters. The map can then be analyzed using a machine-learning algorithm to predict any conditions that may lead to a possible correlation with the security risk measures.

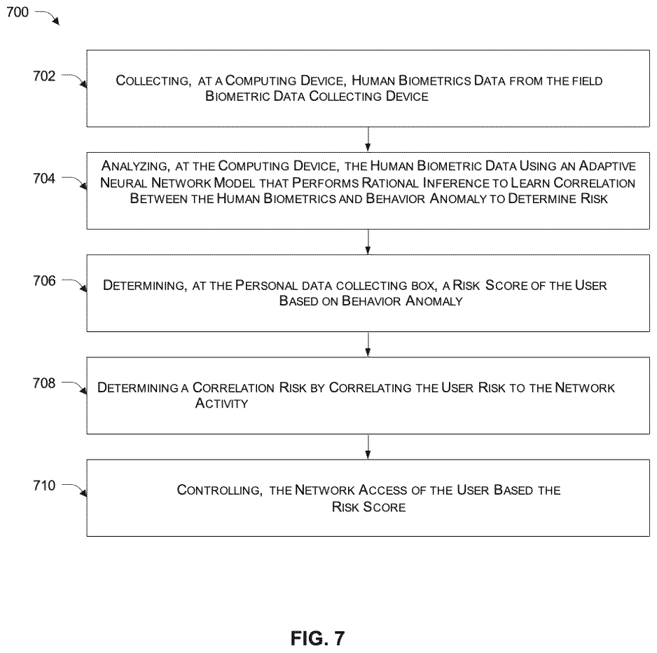

FIG. 7 illustrates a process flow for assessing the risk score of a user in accordance with an embodiment of the present disclosure. The process, referenced as 700, is executed on a computing device and includes the following steps: At block 702, human biometric data is collected, which comprises a combination of field devices functioning as biometric sensing devices. At block 704, the collected biometric data is analyzed using an adaptive neural network model. This model employs rational inference to learn correlations between human biometrics and behavioral anomalies, allowing for the determination of personal disorientation. At block 706, the personal data collection unit determines a risk score for the user based on the detected biometric anomalies. At block 708, a correlation matrix is created by correlating the user's risk score with their network activity log. Finally, at block 710, the system controls the user's network access based on the risk score and/or the correlation matrix.

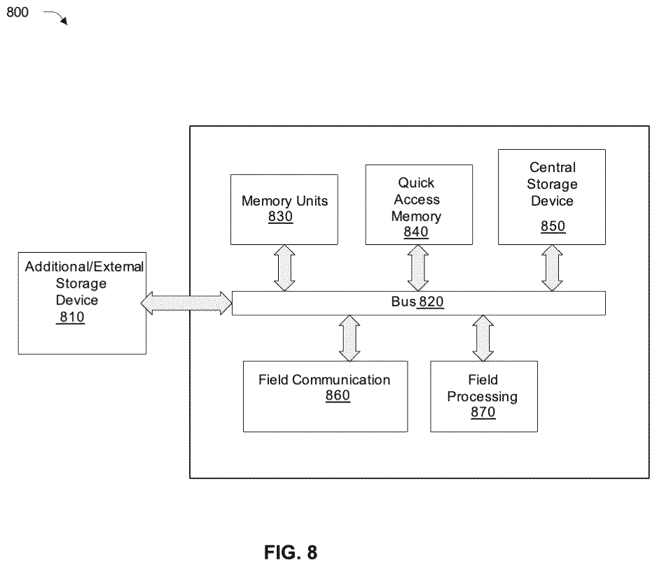

FIG. 8 illustrates an exemplary computer system in which or with which embodiments of the present invention may be utilized. Depending upon the particular implementation, the various process and decision blocks described above may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction. As shown in FIG. 8, the computer system 800 includes a personal data storage device 810, bus 820, main memory 830, read-only memory 840, mass storage device 850, a communication port 860, and a processing unit 870.

In some embodiments, processing circuitry is distributed across multiple separate processors or processing units 870, for example, multiple of the same type of processing units (e.g., two Intel Core i7 processors) or multiple different processors (e.g., an Intel Core i5 processor and an Intel Core i7 processor). Examples of processing circuitry 870 include, but are not limited to, an Intel® Itanium® or Itanium 2 processor(s), or AMD® Opteron® or Athlon MP® processor(s), Motorola® lines of processors, System on Chip (SoC) processors or other future processors. Processing circuitry 1070 may include various modules associated with embodiments of the present invention.

Communication port 860 may include a wireless radio modem, integrated services digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. Communication port 860 can be any RS-232 port for use with a modem-based dialup connection, a 10/100 Ethernet port, a Gigabit, or a 10 Gigabit port using copper or fiber, a serial port, a parallel port, or other existing or future ports. Communication port 860 may be chosen depending on a network, such as a Local Area Network (LAN), Wide Area Network (WAN), or any network to which the computer system connects.

Memory unit 830 may include Random Access Memory (RAM) or any other dynamic storage device commonly known in the art. Read-only memory 840 can be any static storage device(s), e.g., but not limited to, a Programmable Read-Only Memory (PROM) chip for storing static information, e.g., start-up or BIOS instructions for processing circuitry 870. High speed options for the processors and suggested computing circuitry included NVMe, etc.

Mass storage 850 is designed based on NVMe technology. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) 10 recorders, BLU-RAY 3D disc recorders, digital video recorders (DVRs, sometimes called a personal video recorder or PVRs), solid-state devices, quantum storage devices, gaming consoles, gaming media, or any other suitable fixed or removable storage devices, and/or any combination of the same. The non-volatile memory may also be used (e.g., to launch a boot-up routine and other instructions). Cloud-based storage may be used to supplement storage memory in 830. Memory 850 may be any current or future mass storage solution, which can be used to store information and/or instructions.

Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

Bus 820 communicatively couples processor(s) 870 with the other memory, storage, and communication blocks. Bus 820 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 870 to a software system. The infrastructure are designed based on QSFP and SFP+.

Optionally, operator and administrative interfaces, e.g., a display, keyboard, and a cursor control device, may also be coupled to bus 820 to support direct operator interaction with computer systems. Other operator and administrative interfaces can be provided through network connections connected through communication port 860. An external storage device 810 can be any kind of external hard-drives, floppy drives, USB 3-C Drives, Compact SSD Disc, Compact NVMe Drive-Rewritable (CD-RW), Digital Video Disk-Read Only Memory (DVD-ROM). The components described above are meant only to exemplify various possibilities. In no way should the aforementioned exemplary computer system limit the scope of the present disclosure.

Those skilled in the art will appreciate computer system 800 may include more than one processing circuitry 870 and communication ports 860. Processing circuitry 870 should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quadcore, Hexa-core, or any suitable number of cores) or supercomputer.

The computer system 800 may be accessed through a user interface. The user interface application may be implemented using any suitable architecture. For example, it may be a stand-alone application wholly implemented on the computer system 800. The user interfaces application and/or any instructions for performing any of the embodiments discussed herein may be encoded on computer-readable media. Computer-readable media includes any media capable of storing data. In some embodiments, the user interface application is a client server-based application. Data for use by a thick or thin client implemented on an electronic device computer system 800 is retrieved on-demand by issuing requests to a server remote to the computer system 800. For example, computing device 800 may receive inputs from the user via an input interface and transmit those inputs to the remote server for processing and generating the corresponding outputs. The generated output is then transmitted to the computer device for presentation to the user.

While embodiments of the present invention have been illustrated and described, it will be clear that the invention is not limited to these embodiments only. Numerous modifications, changes, variations, substitutions, and equivalents will be apparent to those skilled in the art without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

This approach is particularly valuable for individuals, parents, educators, and businesses who are deeply concerned about the cybersecurity risks associated with their own or others' online activities. By providing a customized security layer that adapts to the user's behavior and needs, this system marks a significant step forward in proactive personal cybersecurity management.

In summary, This innovative system marks a breakthrough in personal security technology by integrating behavior analysis with time-of-day patterns, enhancing the security features used in daily life. It leverages biometric data to create a highly secure and personalized user experience, particularly when interacting with various field devices. This sophisticated system ties together a central data collection unit with an array of field devices equipped with biometric sensors. These devices capture personal data, including subtle behavioral patterns linked to specific times of the day, offering insights into the user's routine and habits. This time-of-day behavioral analysis adds an extra layer of security, as the system can identify anomalies or deviations from the usual patterns, thereby increasing vigilance at times when the user might be more vulnerable.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded to the widest scope consistent with the principles and novel features disclosed herein. It is contemplated that additional embodiments are within the spirit and true scope of the disclosed subject matter.

1. A security fob-ring in communication with a security system for assessing a user's security risk based on daily Biometric behavior anomalies, the system comprising:
a) a processing unit;
b) a memory unit; and
c) a plurality of coded instructions, stored in the memory unit, that, when executed by the processing unit, cause the system to:
i. collect a plurality of human biometric data from a biometric reader;
ii. analyze the plurality of human biometric data using an adaptive neural network model that performs rational inference to learn the correlation between the plurality of human biometric data and daily biometric behavior anomalies to determine the user's security risk;
iii. determine a risk score of the user based on the daily biometric behavior anomalies, and
iv. control access of the user based on the risk score by alerting the user, disconnecting or preventing user access;
wherein the security fob-ring enhance physical access control by integrating biometric data and user behavior patterns for authentication by gathering biometric information, from a distributed network.

2. The system of claim 1, wherein the adaptive neural network model is trained using a two-phase machine learning engine in combination with a spiking recurrent network model.

3. The system of claim 2, wherein the two-phase machine learning engine predicts the risk score for a set of predefined security hardenings.

4. The system of claim 2, wherein the two-phase machine learning engine, in a first mode, predicts a set of upcoming behavior transitions during an intense and previously unseen task by utilizing a temporal context of daily biometric behavior and simulating attention shifts.

5. The system of claim 2, wherein the two-phase machine learning engine in second mode, identifies a set of correlating points between a set of simulated behavior patterns and a set of risk disorders.

6. The system of claim 1, wherein the adaptive neural network model is based on Generic-Leaky-Integrate-and-Fire (GLIF) neural network model.

7. The system of claim 1, wherein the adaptive neural network model is trained using a set of recorded personal behavior data comprising several populations of equivalently structured, interconnected neurons represented as generic leaky integrate-and-fire neurons, trained with spike-timing-dependent plasticity (STDP).

8. The system of claim 1, further comprising a correlation matrix determined by correlating the risk score through the distributed network, wherein network access is controlled based on the correlation matrix.

9. The system of claim 8, wherein the risk score of the user is determined based on the correlation matrix using a machine learning model.

10. A method for assessing a security risk of a user, the method comprising the steps of:
a) collecting, at a computing device, human biometrics data, comprising daily activity data from a plurality of field biometric sensing devices;
b) analyzing, at the computing device, the human biometrics data using an adaptive neural network model that performs rational inference to learn a correlation between a human biometric anomalies and the security risk of the user to determine a security hardening;
c) determining, at the computing device or a personal data-collecting unit, a risk score of the user based on a daily behavior anomalies of the user;
d) determining a correlation matrix by comparing the risk score of the user, and
e) controlling a network access by the computing device to regulate security access based on the risk score.

11. The method of claim 10, wherein controlling the network access comprises alerting the user, disconnecting the network connection of the user and notifying an administrative user.

12. The method of claim 10, wherein the adaptive neural network model is trained using a two-phase machine learning engine in combination with a spiking recurrent network model.

13. The method of claim 12, wherein the two-phase machine learning engine is used to predict the security risks of the user.

14. The method of claim 12, wherein the two-phase machine learning engine, in a first mode, predicts upcoming behavior transitions during an intense and unseen visual task by exploiting a temporal context of behavior stall and simulating attention shifts.

15. The method of claim 12, wherein the two-phase machine learning engine, in second mode, identifies a set of correlating points between simulated behavior patterns and security risks.

16. The method of claim 10, wherein the adaptive neural network model is based on Generic-Leaky-Integrate-and-Fire (GLIF) neural network model.

17. The method of claim 10, wherein the adaptive neural network model is trained using a recorded behavior shift data comprising populations of equivalently structured, interconnected neurons represented as generic leaky integrate-and-fire neurons, trained with spike-timing-dependent plasticity (STDP).

18. The method of claim 10, further comprising determining a correlation matrix by correlating the risk score with a network activity log of the user, wherein the network access is controlled based on the correlation matrix.

19. The method of claim 18, wherein the risk score of the user is determined based on the correlation matrix using a machine learning model.
